(19) United States
(12) Patent Application Publication
(10) Pub. No.: US 2011/0069695 A1
(43) Pub. Date: Mar. 24, 2011

(54) Adaptive polling method for real-time traffic

(75) Inventors: Dan Keun Sung, Daejeon (KR); Young Ik Seo, Seoul (KR); Hu Jin, Daejeon (KR)

(73) Assignee: KOREA ADVANCED INSTITUTE OF SCIENCE AND TECHNOLOGY, Deajeon (KR)

(21) Appl. No.: 12/656,672

(22) Filed: Feb. 12, 2010

(30) Foreign Application Priority Data
Sep. 21, 2009 (KR) 10-2009-0088940

(51) Int. Cl. H04J 3/16

(52) U.S. Cl. 370/346

(57) ABSTRACT

An adaptive polling method for real-time traffic, including settling a value of an initial polling period Tpi and a value of an adaptive polling period Tpa; firstly allocating an uplink polling resource to a terminal; if a new packet is generated from the terminal in the period of the firstly allocated polling resource, receiving size information of the packet by a base station through the polling resource, and secondly allocating a polling resource through a corresponding frame of the initial polling period Tpi set for a next polling; and if no packet is generated from the terminal in the period of the secondly allocated polling resource, thirdly allocating a polling resource through a corresponding frame of the adaptive polling period Tpa set for the next polling.

### FIELD OF THE INVENTION

The present invention relates to an adaptive polling method for real-time traffic, and more particularly, to a method which accepts periodic real-time traffic, as well as non-periodic real-time traffic, by setting an initial polling period Tpi and an adaptive polling period Tpa in advance through dynamic service addition (DSA) scheme or dynamic service change (DSC) scheme, determining the presence or absence of an uplink packet transmission request depending on whether or not a new packet is generated every period, and determining a next polling time instant depending on the adaptively set polling period, in a worldwide interoperability for microwave access (WiMAX) device using an orthogonal frequency division multiple access (OFDMA) scheme.

### BACKGROUND OF THE INVENTION

A wireless communication technology is a technology that allows users to communicate without location limitations or wired limitations. Although this technology was started with the support of voice service, it is currently evolving on the basis of high-speed packet data support, and research and development are underway to interface this technology with the Internet and other various technologies.

One of the most typical communication methods of this wireless communication technology is a WiMAX system, which is known as a broadband wireless communication system. The WiMAX system suggests that communication can be executed using an orthogonal frequency division multiplexing (OFDM) scheme or OFDMA scheme. The WiMAX system is advantageous for high-speed and large-volume data communication because it has a broader bandwidth and can use more resources than the existing third-generation mobile communication system. Thus, the commercialization of the WiMAX system is currently being accelerated.

The wireless access scheme of the broadband wireless communication system as stated above is standardized by the institute of electrical and electronics engineers (IEEE) 802.16 standardization group, which is one of the international standardization organizations.

An IEEE 802.16 mobile WiMAX network (e.g., WiBro network) includes a base station (BS), a mobile station (MS), an access router, and the like. The IEEE 802.16 protocol is applied to the sections between the BS and the MS, which describes a structure of a general IEEE 802.16 WiBro network.

The IEEE 802.16 WiBro network can be composed of an MS that is a user terminal supporting the IEEE 802.16 protocol, a BS that controls and manages a connection with the MS, and an access router that transmits traffic received through the BS to an Internet backbone network.

The IEEE 802.16 WiBro system provides a variety of quality of services (QoSs). That is, in the IEEE 802.16 WiBro system, the properties of a physical medium, such as a data transmission rate, may rapidly vary depending on the characteristics and environment of a wireless medium, unlike in a wired network.

In the IEEE 802.16 WiBro system, a service class is defined to ensure that the MS has good QoS. More specifically, in the IEEE 802.16 Wibro system, using a control channel in downlink, resources for data transmission are allocated to MSs through a downlink control channel in order for the MSs to send data in uplink.

However, since the BS does not have any knowledge of the presence or absence and size of data for the MS, various scheduling methods for uplink have been suggested. These methods include an unsolicited grant service (UGS), a real-time polling service (rtPS), an enhanced-real-time polling service (ertPS), a non-real-time polling service (nrtPS), and a best effort service (BE).

The UGS is a service that periodically allocates a fixed bandwidth for real-time service, which is a typical example of a real-time data transmission service ensuring resource allocation without separate additional competition or request and providing transmission having a fixed size and a periodic interval, such as a VoIP service. However, inefficient utilization of the resources causes a problem in a variable rate environment and during a silence period.

The rtPS and the ertPS are services supporting bandwidth allocation by polling, which are a typical example of real-time bandwidth request and polling, and variable data scheduling and shaping and include a video call, a video game, video on demand (VOD), etc. However, the rtPS and ertPS also may cause a problem of resource allocation made even in a period in which traffic is not generated yet.

The nrtPS is a service supporting bandwidth allocation by polling, which is a typical example of a service sensitive to a minimum data processing rate compensation and packet loss and includes a large volume of file transfer protocol (FTP), multimedia email, etc. The BE is a service allocating uplink resources for transmitting a bandwidth request header in response to a bandwidth request, which is a typical example of proportional-fair scheduling and efficient data transmission service and includes a web browsing, email service, a short message transmission service, low speed file transmission, etc.

Among them, the polling service is to notify the BS of whether or not data to be sent by the MS exist in a polling resource and of the size information of the data, if exists, when the BS allocates the polling resource to the MS. If the MS transmits the size information of the data to the BS using the polling resource, the BS allocates a modulation and coding scheme (MCS) and the size and position of the resource to the MS using uplink/downlink map information elements so that the MS transmits data packets in uplink.

However, among the scheduling methods as mentioned above, the rtPS is sensitive to latency and has a lower priority than the UGS class because the rtPS aims at a real-time service.

Moreover, the rtPS scheduling must satisfy the characteristics of real-time traffic, and notify the BS of an amount of bandwidth required by the MS. In order to satisfy the above requirements, the BS performs periodic polling with regard to a particular MS.

Especially, since a polling period is set to a single value, Tp, correlation between new packet generation times cannot be controlled, which causes a polling delay or a polling over. This overhead leads to a problem due to resource waste or traffic delay.

### SUMMARY OF THE INVENTION

In view of the foregoing, the present invention provides an adaptive polling method for non-periodic real-time traffic, which can control a correlation between packet generation times by setting an initial polling period Tpi and an adaptive polling period Tpa in advance when a BS and an MS establish a connection to a specific service using DSA or during the provision of a specific service using DSC, and allocating the next polling after the preset initial polling period Tpi if a new packet is generated (e.g., there is a packet transmission request) in the previous period or allocating the next polling after the preset adaptive polling period Tpa if there is no new packet generated (e.g., there is no packet transmission request) in the previous period, in a WiMAX device using an OFDMA scheme.

In accordance with the present invention, there is provided an adaptive polling method for real-time traffic, including:

settling a value of an initial polling period Tpi and a value of an adaptive polling period Tpa;

firstly allocating an uplink polling resource to a terminal;

if a new packet is generated from the terminal in the period of the firstly allocated polling resource, receiving size information of the packet by a base station through the polling resource, and secondly allocating a polling resource through a corresponding frame of the initial polling period Tpi set for a next polling; and

if no packet is generated from the terminal in the period of the secondly allocated polling resource, thirdly allocating a polling resource through a corresponding frame of the adaptive polling period Tpa set for the next polling.

### BRIEF DESCRIPTION OF THE DRAWINGS

The above and other objects and features of the present invention will become apparent from the following description of embodiments, given in conjunction with the accompanying drawings, in which:

FIG. 1 is a view illustrating a process for setting a value of an initial polling period Tpi and a value of an adaptive polling period Tpa in advance when a BS and an MS establish a connection to a specific service using DSA in uplink in accordance with an embodiment of the present invention;

FIG. 2 is a view illustrating a process for changing a preset value of an initial polling period Tpi and a preset value of an adaptive polling period Tpa during the provision of an artPS service using DSC in uplink in accordance with the embodiment of the present invention;

FIG. 3 illustrates a detailed flowchart for the adaptive polling method for non-periodic real-time traffic in accordance with the embodiment of the present invention;

FIG. 4 is a view illustrating the setting of a polling period for polling in accordance with the embodiment of the present invention;

FIG. 5 shows a graph comparing average polling resources used for one MS when a gaming traffic service is provided in the artPS scheme of the present invention and the conventional rtPS scheme; and

FIGS. 6A and 6B illustrate views showing gaming users that can be supported by one BS when the artPS scheme of the present invention and the conventional rtPS scheme are used, respectively.

### DETAILED DESCRIPTION OF THE EMBODIMENT

Hereinafter, an embodiment of the present invention will be described in detail with reference to the accompanying drawings. In the following description, well-known functions or constitutions will not be described in detail if they would obscure the invention in unnecessary detail. Further, the terminologies to be described below are defined in consideration of functions in the present invention and may vary depending on a user's or operator's intention or practice. Thus, the definitions should be understood based on all the contents of the specification.

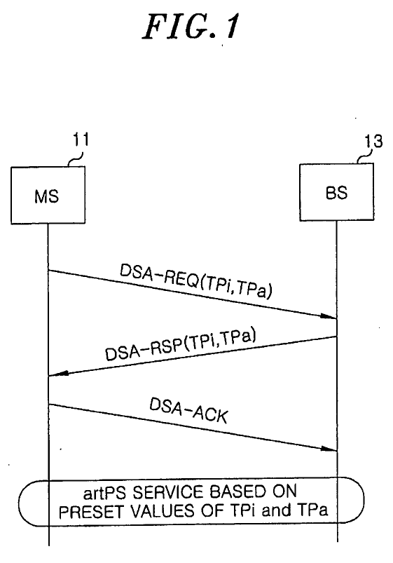

FIG. 1 is a view illustrating a process for settling a value of an initial polling period Tpi and a value of an adaptive polling period Tpa in advance when a BS and an MS establish a connection to a specific service using DSA in uplink in accordance with an embodiment of the present invention.

Referring to FIG. 1, there is illustrated that a request for connection to a specific service is made in uplink, namely, from an MS 11 to a BS 13. First of all, the MS 11 transmits to the BS 13 a DSA-REQ (request) message requesting a link flow establishment, in which a value of an initial polling period Tpi and a value of an adaptive poling period Tpa are incorporated.

The BS 13 processes the establishment of an uplink session, settles a polling period for the MS 11 based on the values of the initial polling period Tpi and the adaptive poling period Tpa, included in the DSA-REQ message, generates a DSA-RSP (response) message and indicating that the value of the settled initial polling period Tpi and the value of the settled adaptive poling period Tpa have been settled, and transmits the DSA-RSP message to the MS 11.

In response to the DSA-RSP message, the MS 11 that generates a DSA-ACK message indicating that uplink flow establishment negotiation and the settlement of the values of the initial polling period Tpi and the adaptive poling period Tpa have been finished and then transmits the DSA-ACK message to the BS 13 so that an artPS service can be initiated.

Although the foregoing description has been made with respect to the case where a request for connection to a specific service is made in uplink from the MS 11 to the BS 13, the value of the initial polling period Tpi and the value of the adaptive poling period Tpa, can be set in advance even when a request for connection to a specific service is made in downlink from the BS 13 to the MS 11.

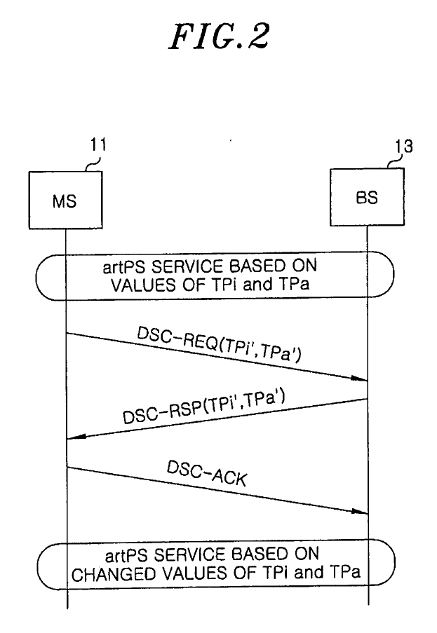

FIG. 2 is a view illustrating a process for changing the preset value of the initial polling period Tpi and the preset value of the adaptive polling period Tpa during the provision of an artPS service using dynamic service change (DSC) in uplink in accordance with the embodiment of the present invention.

In FIG. 2, when a service change request is made in uplink, namely, from the MS 11 to the BS 13, a new value of the initial polling period Tpi′ and a new value of the adaptive poling period Tpa′ desired to be changed are incorporated in a DSC-REQ message requesting a service change, and the DSC-REQ message is then transmitted from the MS 11 to the BS 13.

The BS 13 processes the service change, changes and sets the polling period between the BS 13 and the MS 11 in advance based on the values of the initial polling period Tpi′ and the adaptive poling period Tpa′, incorporated in the DSC-REQ message, generates a DSC-RSP (response) message indicating that the values of the initial polling period Tpi′ and the adaptive poling period Tpa′ are changed and preset, and transmits the DSC-RSP message to the MS 11.

The MS 11, in response to the DSC-RSP message, generates a DSC-ACK message indicating that an uplink service change and the changing and presetting of the values of the initial polling period Tpi′ and the adaptive poling period Tpa′ have been finished and then transmits the DSC-ACK to the BS 13 so that the artPS service can be initiated based on the changed and set polling period.

Although the foregoing description has been made with respect to the case where a service change request is made in uplink from the MS 11 to the BS 13, the value of the initial polling period Tpi′ and the value of the adaptive poling period Tpa′ may be changed even when a service change request is made in downlink from the BS 13 to the MS 11.

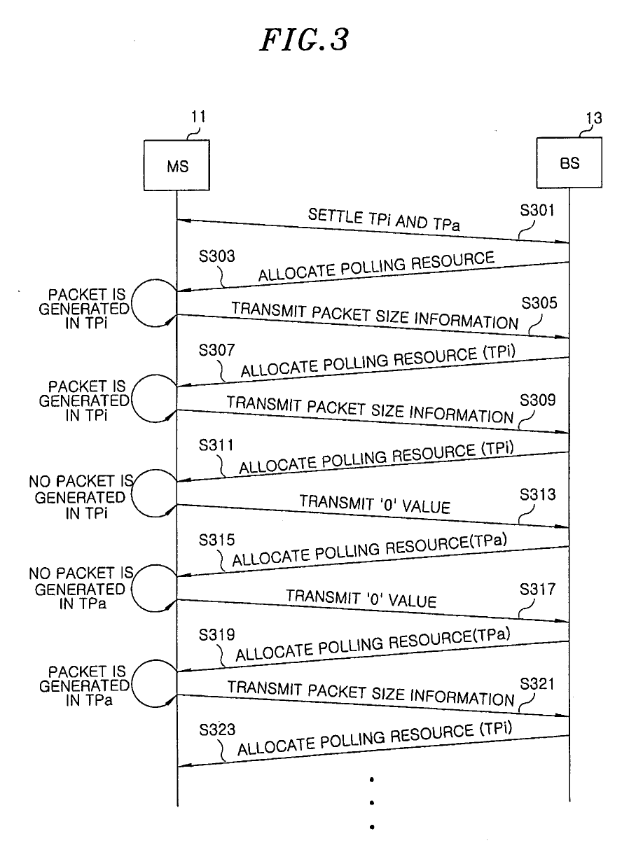

FIG. 3 illustrates a detailed flowchart of the adaptive polling method for non-periodic real-time traffic in accordance with the embodiment of the present invention. Since the present invention suggests a polling method, the resource allocation based on downlink map information of the BS 13 for packet transmission and a packet transmission of the corresponding MS 11 are omitted from the flow, the process of which is the same as the process of rtPS in the IEEE 802.16 standard.

In step S301, the BS 13 sets an initial polling period Tpi and an adaptive polling period Tpa in advance when the BS 13 and the MS 11 establish a connection to a specific service using DSA or during the provision of a specific service using DSC.

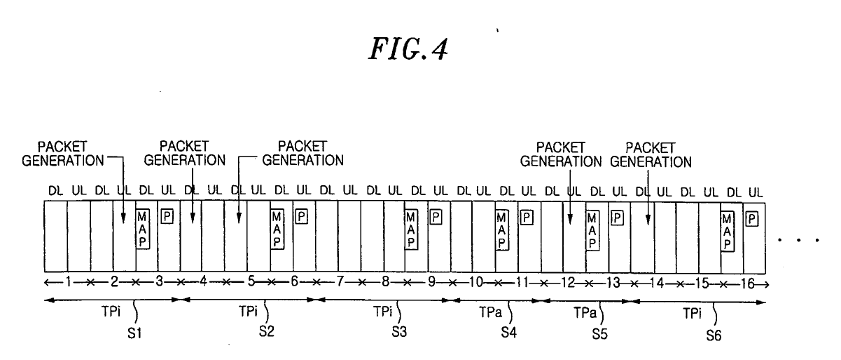

In one example, it is assumed that the value of the initial polling period Tpi and the value of the adaptive polling period Tpa, which are the parameters of the artPS, have ‘3’ frames and ‘2’ frames, respectively, as shown in FIG. 4.

Also, as shown in FIG. 4, a certain type of traffic providing the artPS service requests for data transmission in real time, but packet generation is non-periodic and the packet size is also varied each time. Moreover, it is assumed that one frame in the traffic shown in FIG. 4 consists of a downlink DL and an uplink UL, and each frame is sequentially numbered (e.g., 1 to 16).

Next, in step S303, the BS 13 allocates a polling resource to the MS 11 in the uplink UL of the third frame in the initial polling period Tpi within the certain type of traffic providing the artPS service shown in FIG. 4, for example.

A packet is generated in the uplink UL period of the second frame shown in FIG. 4, that is, in the initial polling period Tpi (S1) and therefore, the MS 11 transmits the size information of the generated packet to the BS 13 through the third frame in which the polling resource is allocated, in step S305.

Although not included in FIG. 3, the BS 13 that receives the packet size information allocates the resource for packet transmission in the UL period based on map information in the next frame, fourth frame, and the MS 11 transmits a packet using the assigned UL resource.

Next, a packet transmission request is made through the third frame of FIG. 4 in which the polling resource is allocated and therefore, the BS 13 allocates a polling resource to the MS 11 in the UL period of the sixth frame after the lapse of the initial polling period Tpi preset for the next polling in step S307.

New packets are generated in the DL periods of the fourth and fifth frames shown in FIG. 4, that is, in the initial polling period Tpi (S2) and, therefore, the MS 11 then transmits the size information of the generated packets to the BS 13 through the sixth frame in which the polling resource is allocated in step S309.

Next, a packet transmission request is made through the allocated polling resource of the sixth frame of FIG. 4 in which the polling resource is allocated, and thus the BS 13 allocates a polling resource to the MS 11 in the UL of the ninth frame after the lapse of the initial polling period Tpi preset for the next polling in step S311.

there is no new packet generated in the initial polling period Tpi (S3), and therefore, the MS 11 transmits a ‘0’ value to the BS 13 through the polling resource allocated to the ninth frame of FIG. 4 or indicates that there is no response, that is, there is no packet to be transmitted, in step S313.

Subsequently, there is no packet transmission request made through the polling resource allocated to the ninth frame of FIG. 4 and therefore, the BS 13 then allocates a polling resource to the MS 11 in the UL period of the eleventh frame after the lapse of the adaptive polling period Tpa preset for the next polling in step S315.

There is no new packet generated in the initial polling period Tpi (S4), and therefore, in step S317, the MS then transmits a ‘0’ value to the BS 13 through the polling resource allocated to the eleventh frame of FIG. 4 or indicates that there is no response, that is, there is no packet to be transmitted.

Next, there is no packet transmission request made through the polling resource allocated to the eleventh frame of FIG. 4, and therefore, in step S319, the BS 13 then allocates a polling resource to the MS 11 in the UL period of the thirteenth frame after the lapse of the adaptive polling period Tpa preset for the next polling.

New packets are generated in the UL period of the twelfth frame shown in FIG. 4, that is, in the adaptive polling period Tpa (S5), and therefore, in step S321, the MS 11 transmits the size information of the arrived packets to the BS 13 through the polling resource allocated to the thirteenth frame.

Next, a packet transmission request is made through the allocated polling resource of the thirteenth frame of FIG. 4 in which the polling resource is allocated, and therefore, in step S323, the BS 13 allocates the polling resource to the MS 11 in the UL of the sixteenth frame after the lapse of the initial polling period Tpi (S6) preset for the next polling in step S323.

Here, part of traffic allocating the polling resource is represented by way of an example in FIG. 4, and the resource allocation scheme for a data packet in UL is not represented. The resource allocation scheme is the same as in the rtPS and the detailed description thereof will not be described.

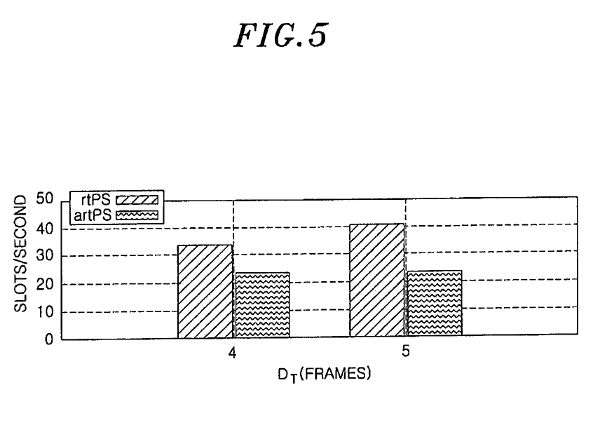

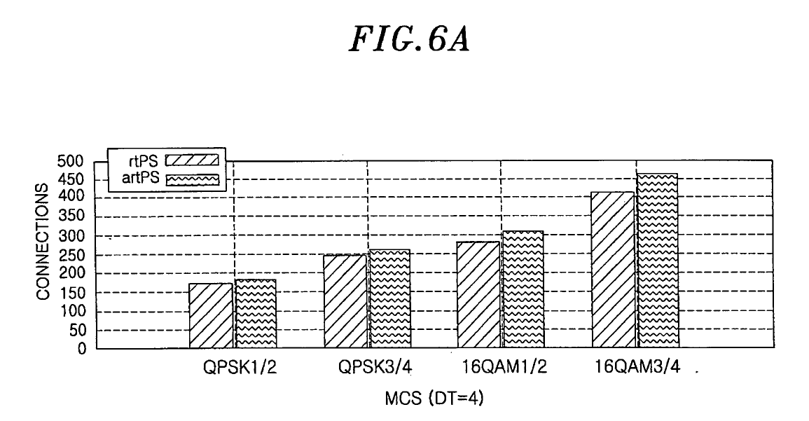

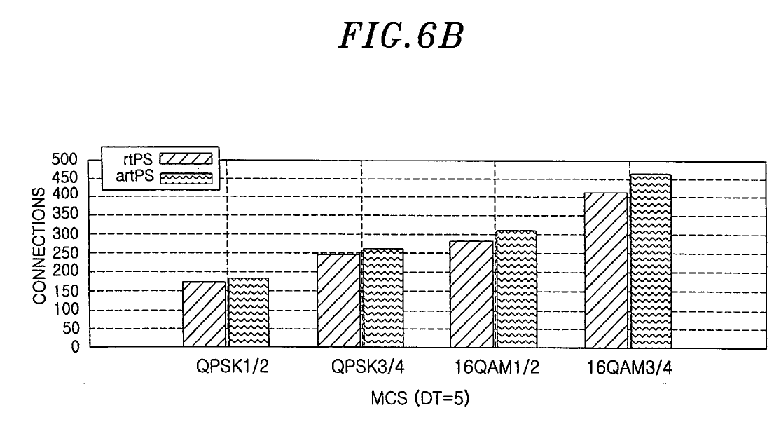

FIG. 5 and FIGS. 6A and 6B illustrates views describing a simulation test for a mobile WiMAX system based on a gaming traffic model suggested in the IEEE 802.16m evaluation methodology document (EMD) in the case of using an artPS service in accordance with the present invention. That is, a delay constraint for gaming traffic is set to 50 ms based on the IEEE 802.16m EMD. In general, if 90% of the packets transmitted by the MS arrive within this delay constraint, a QoS is satisfied, and a processing delay time D_{T} at the BS is preferably in the range of 18 ms to 22 ms or in the range of 23 ms to 27 ms as in the artPS shown in FIG. 5.

A calculation example of the values of the initial polling period Tpi and adaptive polling period Tpa in this gaming traffic condition will be given below.

That is, when D_{T}=20 ms, the initial polling period Tpi=7 frames, the adaptive polling period Tpa=6 frames, and Tp of rtPS is 6 frames.

When D_{T}=25 ms, the initial polling period Tpi=7 frames, the adaptive polling period Tpa=5 frames, and Tp of rtPS is 5 frames. Here, one frame is 5 ms.

FIG. 5 shows a graph comparing the average polling resources used for one MS when a gaming traffic service is provided in rtPS and artPS schemes. In comparison to rtPS, the artPS of the present invention uses only 58.5% (DT=20 ms) or 69.1% (D_{T}=25 ms) of polling resources used by the rtPS.

FIGS. 6A and 6B illustrates views showing the number of gaming users that can be supported by one BS when the rtPS and artPS are used while changing modulation and coding scheme at D_{T}=4 frames (or 20 ms) and D_{T}=5 frames (or 20 ms), respectively. If it is assumed that an uplink UL resource has 210 slots/frame, the use of the artPS of the present invention can increase the number of users by 4.6% to 18.2% compared to the use of the rtPS.

Meanwhile, the adaptive polling method for real-time traffic in accordance with the present invention described above may be implemented as computer-readable codes on a computer-readable recording medium. Any kind of data recording devices that can be read by a computer system may be employed as the computer-readable recoding medium. Examples of the computer-readable recording medium include ROM, RAM, CD-ROM, magnetic tape, floppy disk, optical data storage unit, a carrier wave (e.g., transmission via Internet) and the like. Also, the computer-readable codes or program is distributed in a networked computer system, and can be executed in a distributed manner.

As described above, the present invention can control the correlation between new traffic packet generation times by setting an initial polling period Tpi and an adaptive polling period Tpa in advance when a BS and an MS establish a connection to a specific service using DSA or during the provision of a specific service using DSC, and allocating the next polling after the preset initial polling period Tpi if a new packet is generated in the previous period or allocating the next polling after the preset adaptive polling period Tpa if there is no new packet generated in the previous period, thereby reducing a polling delay or a polling over and effectively accepting a non-periodic real-time traffic service.

Moreover, the artPS can replace the rtPS service owing to its characteristics if an initial polling period Tpi and an adaptive polling period Tpa are set to the same value. Thus, the artPS can support both periodic and non-periodic real-time services and requires no additional control signal between an BS and an MS during the provision of the service, thereby providing a variety of real-time services, including an online game, a video call, a video game, video on demand (VOD), etc.

While the invention has been shown and described with respect to the particular embodiments, it will be understood by those skilled in the art that various changes and modification may be made.

What is claimed is:

1. An adaptive polling method for real-time traffic, comprising:
settling a value of an initial polling period Tpi and a value of an adaptive polling period Tpa;
firstly allocating an uplink polling resource to a terminal;
if a new packet is generated from the terminal in the period of the firstly allocated polling resource, receiving size information of the packet by a base station through the polling resource, and secondly allocating a polling resource through a corresponding frame of the initial polling period Tpi set for a next polling; and
if no packet is generated from the terminal in the period of the secondly allocated polling resource, thirdly allocating a polling resource through a corresponding frame of the adaptive polling period Tpa set for the next polling.

2. The adaptive polling method of claim 1, wherein said settling the value of the initial polling period Tpi and the value of the adaptive polling period Tpa includes:
when a specific service is connected for the terminal using dynamic service addition (DSA) on the uplink, receiving a DSA-REQ message containing the value of the initial polling period Tpi and the value of the adaptive polling period Tpa;
settling the value of the initial polling period Tpi and the value of the adaptive polling period Tpa for the terminal in response to the received DSA-REQ message, and then generating a DSA-RSP message indicative of the settlement of the values and transmitting the DSA-RSP message to the terminal; and
receiving a DSA-ACK message, indicating that the settlement of the values of the initial polling period Tpi and the adaptive poling period Tpa has been finished, from the terminal and initiating the specific service.

3. The adaptive polling method of claim 1, wherein said settling a value of an initial polling period Tpi and a value of an adaptive polling period Tpa includes:
when a specific service request is made for the terminal using dynamic service change (DSC) in uplink, receiving a DSC-REQ message containing the values of the initial polling period Tpi′ and the adaptive polling period Tpa′ desired to be changed;
changing the values of the initial polling period Tpi′ and the adaptive polling period Tpa′ for the terminal in response to the received DSC-REQ message, and then generating a DSC-RSP message indicative of the changing of the values and transmitting the DSC-RSP message to the terminal; and
receiving a DSC-ACK message, indicating that the changing and setting of the value of the initial polling period Tpi′ and the value of the adaptive poling period Tpa′ have been finished, from the terminal and initiating the specific service;

4. The adaptive polling method of claim 1, wherein if no packet is generated in the period of the secondly allocated polling resource, a ‘0’ value is received through the frame in which the polling resource is allocated.

5. The adaptive polling method of claim 1, wherein if no packet is generated in the period of the secondly allocated polling resource, no response is received through the frame in which the polling resource is allocated.

6. A computer-readable recording medium having a program stored thereon for executing the method of any one of claims 1 to 5.
